(19) United States
(12) Patent Application Publication
(10) Pub. No.: US 2025/0034827 A1
(43) Pub. Date: Jan. 30, 2025

(54) DAMPENING ASSEMBLY FOR VIBRATORY PILE DRIVERS

(71) Applicant: Antaeus Foundation Equipment LLC, Seattle, WA (US)

(72) Inventor: John L. White, Seahurst, WA (US)

(21) Appl. No.: 18/911,229

(22) Filed: Oct. 9, 2024

Related U.S. Application Data
(63) Continuation of application No. 17/692,681, filed on Mar. 11, 2022, now Pat. No. 12,116,744.

(51) Int. Cl. E02D 11/00; E02D 7/18

(52) U.S. Cl. CPC E02D 11/00; E02D 7/18

(57) ABSTRACT

Dampening assemblies for crane systems and the like. In some embodiments, the assembly may comprise an upper connecting member and a lower connecting member, along with a housing and an inner assembly. One or more elastomer shock absorbing members may be connected between the inner assembly and the housing. In operation, weight on the dampening assembly may result in movement of the housing with respect to the inner assembly, which movement results in a corresponding shearing of the one or more shock absorbing members, thereby reducing vibration of a weight coupled with the dampening assembly.

### CROSS-REFERENCE TO RELATED APPLICATIONS

This application is a continuation of co-pending application Ser. No. 17/692,681 filed on Mar. 11, 2022, and titled “DAMPENING ASSEMBLY FOR VIBRATORY PILE DRIVERS,” which application is hereby incorporated herein by reference in its entirety.

### TECHNICAL FIELD

This invention relates generally to vibratory pile drivers, and more particularly concerns damping mechanisms to reduce shaking and vibration of vibratory pile drivers during operation.

### BACKGROUND OF THE INVENTION

During operation of certain vibratory pile drivers, shaking or vibration of the pile driver occurs, particularly during starting and starting of operation, but during the entire operation as well. Such effects are undesirable, for both operators and users of such pile drivers. Various attempts have been made to reduce the shaking/vibration of such pile drivers during operation. One known arrangement is a suppressor system using elastomers, such as shown in U.S. Pat. No. 5,263,544 to White. Such arrangements include multi-stage systems using various elastomer arrangements, all in order to smooth out shaking/vibration during operation of pile drivers. Another arrangement to smooth out shaking is often referred to as damping or a dampening system. In one such arrangement, two opposing plates are arranged with a solid rubber barrel-like member connected between them, operating in compression. This arrangement has had some positive effect in reducing shaking action of pile drivers. An alternative to such a solid rubber arrangement uses an elastomer member in place of the solid rubber member, but also operating in compression which has been shown not to be effective. Further, if the elastomer fails in such an arrangement, the load falls.

Accordingly, an effective dampening system would be advantageous in the pile driving art.

### SUMMARY OF THE INVENTION

Accordingly, disclosed is a dampening assembly for use in a pile driving system for pile driving and/or pile pulling, the dampening assembly comprising: a lower connecting member for connection to the vibratory device portion of a pile driving system; an upper connecting member for connecting to a crane assembly for the pile driving system, the upper connecting member connected to an outer housing for the dampening assembly; an inner assembly connected to the lower connecting member, the inner assembly including a safety pin extending through an opening in the outer housing, wherein the dampening assembly includes an inner housing connected to the outer housing; and opposing elastomer shock absorbing members connected between the inner assembly and extending to the inner housing, wherein in operation, weight on the dampening assembly results in a corresponding stretching of the opposing elastomer members, reducing vibration of the pile driving system during operation.

The features, structures, steps, or characteristics disclosed herein in connection with one embodiment may be combined in any suitable manner in one or more alternative embodiments.

### BRIEF DESCRIPTION OF THE DRAWINGS

FIG. 1 is a perspective view of a vibratory pile driving system, showing the dampening assembly of the present invention.

FIG. 2 is an elevational, partially cutaway, view of the dampening assembly of the present invention, without force on the dampening assembly.

FIG. 3 is an elevational, partially cutaway, view of the dampening assembly, with significant weight on the assembly.

FIG. 4A is a simplified elevational view showing the stretching of the elastomer members of the dampening assembly without any elastomer stretching.

FIG. 4B is a simplified elevational view showing stretching of the elastomer members to 4 inches.

FIG. 4C is a simplified elevational view showing stretching of the elastomer members to 14 inches.

### BEST MODE FOR CARRYING OUT THE INVENTION

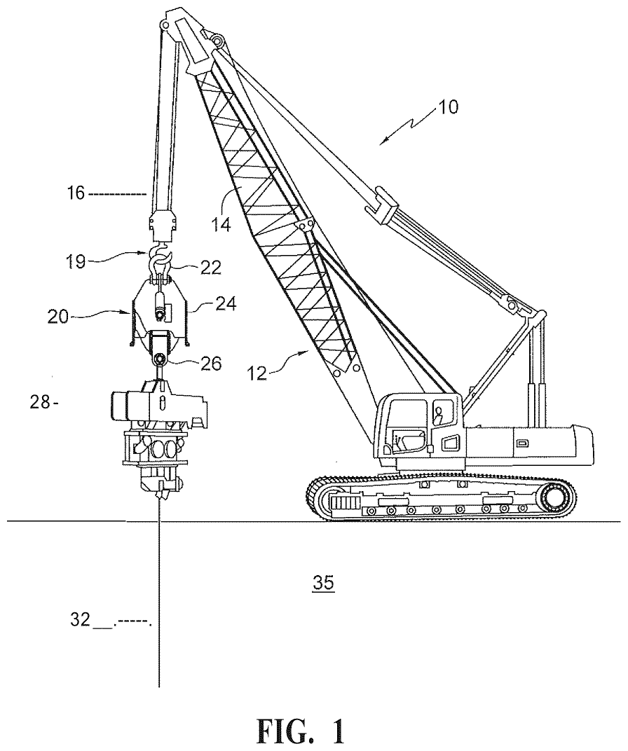

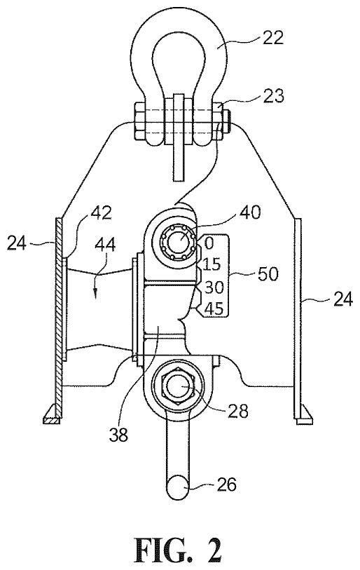

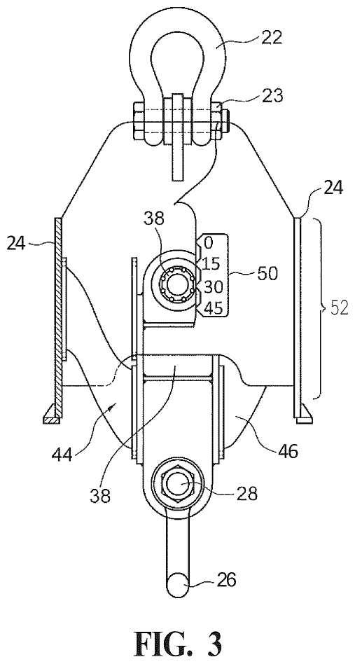

Referring now to FIGS. 1-3, a vibratory pile driver system is shown generally at 10. The system includes a conventional construction crane 12 with an extended boom 14 and a crane line shown at 16. At the end of crane line 16 is a crane hook 19 which is connected to the dampening assembly 20 of the present invention, by a first shackle member 22 which is bolted by assembly 23 to an outer housing member 24 of the dampening assembly 20. A second shackle member 26, positioned at 90 degrees to the first shackle member 22, is connected to a vibratory pile driver (vibro) 28, which operates on a pile 32 in the soil 35. The operation/purpose of the arrangement of FIG. 1, including the dampening assembly 20, is to reduce, even significantly reduce, the transfer of vibrations of the vibratory pile driver into the crane line 16 and boom 14. Referring now to FIGS. 2 and 3, the second shackle 26 is connected by a bolt assembly 28 to an inner assembly 38, which includes a pin 40. The inner assembly 38 includes an inner housing 42 which is connected to the outer housing 24. Opposing elastomer shock absorbing members 44 and 46 include inner end plates bolted to the inner assembly 38, extending to the inner housing 42 to which they are also bolted by outer end plates. The elastomeric members 44 and 46 are conventional and well known in the pile driver shock absorbing art. The opposing elastomer members 44 and 46 stretch together during operation of the pile driver. The dampening assembly also includes a weight measuring scale 50 for convenience, but which is not essential for the operation of the dampening assembly. In the embodiment shown, the scale includes weights at 15 ton increments from zero through 45 tons, although the scale could differ in the specific weights measured.

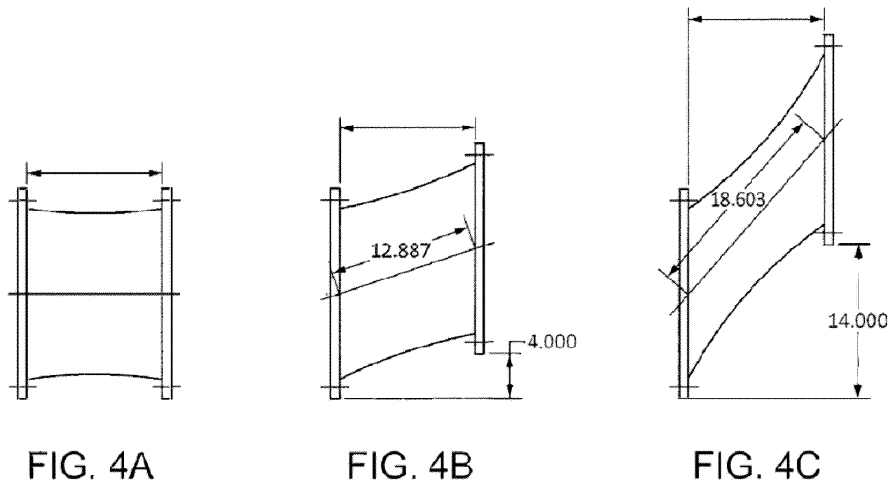

In operation, as weight is applied, the elastomers operate in shear, which is a significant difference relative to other available damping systems which use elastomer(s) operating in compression. Operation of the elastomers in shear is an important aspect of the present invention. FIGS. 4A, 4B and 4C show the condition of the elastomers stretching under 3 weight conditions. In the arrangement shown, the distance between the inner and outer end plates in the elastomers is 12.25 inches, which could be varied. FIG. 4A shows the elastomers under a static (no weight) condition. FIG. 4B shows the elastomers stretched to a length of 13 inches with 4.0 inches of relative movement of the inner assembly produced by 8 tons of weight as an example, while FIG. 4C shows the stretched condition of the elastomers with 14 inches of movement, and a stretched length of 18.6 inches produced by 30 tons of weight. These conditions will vary depending on the weight applied.

It is also important to recognize that with the arrangement of the present invention, if the weight results in a failure or tearing of the elastomers, pin 40 falls to its lowest position in the outer housing, as shown in FIG. 1, but maintains the connection with the vibro so that operation can continue, although shaking/vibration will occur due to the lack of the dampening protection.

It should also be recognized that weights 52 of various amounts can be connected to the exterior of the outer housing, shown on one side only.

Accordingly, a dampening assembly has been disclosed which uses elastomers in a shear arrangement to modulate or modify shaking/vibration during operation of a vibratory pile driver.

Although a preferred arrangement of the present invention has been disclosed for the purpose of illustration, it should be understood that various changes, modifications, and substitutions may be incorporated without departing from the spirit of the invention which is defined by the claims that follow:

1. A dampening assembly, comprising:
an upper connecting member configured to be coupled with a crane assembly;
a lower connecting member configured to be releasably connected to a vibratory pile driver;
an outer housing coupled to either the upper connecting member or the lower connecting member;
an inner assembly coupled to either the lower connecting member or the upper connecting member; and
a pair of opposing elastomeric members coupled between the outer housing and the inner assembly such that weight applied to the lower connecting member results in movement of the inner assembly relative to the outer housing and shearing of the pair of opposing elastomeric members to reduce vibration of the vibratory pile driver during operation.

2. The dampening assembly of claim 1, further comprising a safety member configured to prevent a failure of the pair of opposing elastomeric members from causing the dampening assembly to release the vibratory pile driver.

3. The dampening assembly of claim 2, wherein the safety member comprises a safety pin.

4. The dampening assembly of claim 3, wherein the safety pin extends through an opening, and wherein the safety pin is configured to contact a lower portion of the opening to prevent disconnection of the inner assembly and the outer housing upon failure of the pair of opposing elastomeric members.

5. The dampening assembly of claim 1, wherein the lower connecting member comprises a shackle.

6. A dampening assembly, comprising:
an upper connecting member configured to releasably connect to a crane assembly;
a lower connecting member configured to releasably connect to a weight portion;
an outer housing;
an inner assembly; and
at least one elastomer shock absorbing member connected between the inner assembly and the outer housing, wherein in operation, weight on the dampening assembly results in movement of the outer housing with respect to the inner assembly, which movement results in a corresponding shearing of the at least one elastomer shock absorbing member, thereby reducing vibration of the weight portion during operation.

7. The dampening assembly of claim 6, wherein the weight portion comprises a suspending weight portion of a pile driving system, and wherein shearing of the at least one elastomer shock absorbing member is configured to reduce vibration of the pile driving system during operation.

8. The dampening assembly of claim 7, wherein the lower connecting member comprises a shackle member configured to be releasably connected to the pile driving system.

9. The dampening assembly of claim 6, wherein the at least one elastomer shock absorbing member comprises a plurality of elastomer shock absorbing members.

10. The dampening assembly of claim 9, wherein the plurality of elastomer shock absorbing members comprises a pair of opposing elastomer shock absorbing members.

11. The dampening assembly of claim 6, wherein the upper connecting member is connected to the outer housing.

12. The dampening assembly of claim 11, wherein the lower connecting member is connected to the inner assembly.

13. The dampening assembly of claim 12, wherein each elastomer shock absorbing member of the at least one elastomer shock absorbing member is coupled to an inner end plate at one end thereof, wherein the inner plate is connected to the inner assembly, and wherein each elastomer shock absorbing member of the at least one elastomer shock absorbing member is coupled to an outer end plate at the other end thereof connected to the outer housing.

14. The dampening assembly of claim 6, further comprising a safety member configured to prevent a failure of the at least one elastomer shock absorbing member from causing the dampening assembly to release the weight.

15. The dampening assembly of claim 14, wherein the outer housing comprises an opening comprising a lower end, and wherein, upon failure of the at least one elastomer shock absorbing member, the safety member is configured to fall downwardly to and contact the lower end of the opening in the outer housing to prevent the weight from being released.

16. A dampening assembly for use with a crane system subject to vibration, the dampening assembly comprising:
an upper connecting member configured for connecting to a crane line portion of the crane system,
a housing, wherein the upper connecting member is coupled to the housing;
a lower connecting member for releasably connecting to a weight which would otherwise be connected to the crane line portion of the crane system;
an inner assembly; and
opposing elastomer shock absorbing members connected between the inner assembly and the housing, wherein the opposing elastomer shock absorbing members are configured to shear to move the inner assembly relative to the housing to reduce vibration during operation.

17. The dampening assembly of claim 16, wherein the housing comprises an outer housing, and wherein the upper connecting portion is connected to the outer housing.

18. The dampening assembly of claim 17, wherein the inner assembly is connected to the lower connecting member.

19. The dampening assembly of claim 16, wherein the lower connecting member is positioned at 90 degrees relative to the upper connecting member.

20. The dampening assembly of claim 16, further comprising a safety pin configured to fall downwardly and contact a portion of the housing when the opposing elastomer shock absorbing members fail to prevent the weight from being released upon failure of the opposing elastomer shock absorbing members.
